(19) United States
(12) Patent Application Publication
(10) Pub. No.: US 2011/0283059 A1
(43) Pub. Date: Nov. 17, 2011

(54) TECHNIQUES FOR ACCELERATING COMPUTATIONS USING FIELD PROGRAMMABLE GATE ARRAY PROCESSORS

(75) Inventors: Sundar Govindarajan, Singapore (SG); Vinod Ranganathan Iyer, Singapore (SG); Darran Nathan, Singapore (SG)

(73) Assignee: Progeniq Pte Ltd, Singapore (SG)

(21) Appl. No.: 13/104,579

(22) Filed: May 10, 2011

Related U.S. Application Data
(60) Provisional application No. 61/333,631, filed on May 11, 2010.

(51) Int. Cl. G06F 15/76; G06F 9/06; G06F 12/00

(52) U.S. Cl. 711/104; 712/30; 711/E12.001; 712/E09.003

(57) ABSTRACT

Various embodiments are disclosed for accelerating computations using field programmable gate arrays (FPGA). Various tree traversal techniques, architectures, and hardware implementations are disclosed. Various disclosed embodiments comprise hybrid architectures comprising a central processing unit (CPU), a graphics processor unit (GPU), a field programmable gate array (FPGA), and variations or combinations thereof, to implement raytracing techniques. Additional disclosed embodiments comprise depth-breadth search tree tracing techniques, blocking tree branch traversal techniques to avoid data explosion, compact data structure representations for ray and node representations, and multiplexed processing of multiple rays in a programming element (PE) to leverage pipeline bubble.

### CROSS-REFERENCE TO RELATED APPLICATION

This application claims the benefit under 35 USC §119(e) of U.S. Provisional Patent Application No. 61/333,631, entitled “TECHNIQUES FOR ACCELERATING COMPUTATIONS USING FIELD PROGRAMMABLE GATE ARRAY PROCESSORS,” and filed on May 11, 2010, the contents of which are herein entirely incorporated by reference.

### BACKGROUND

The present disclosure relates to rendering two-dimensional (2D) representations of three-dimensional (3D) scenes composed of shapes using raytracing, and more particularly to techniques for accelerating computations necessary for such raytracing rendering using field programmable gate array processors.

Raytracing is a sophisticated rendering technique in the computer graphics arts used to generate photo-realistic 2D images from 3D scene descriptions with complex light interactions. Raytracing generally involves obtaining a scene description composed of geometric shapes, which describe surfaces of structures in the scene, and can be called primitives. A common primitive shape is a triangle.

Virtual rays of light are traced into the scene from a view point (“a camera”); each ray is issued to travel through a respective pixel of the 2D representation, on which that ray can have an effect. The rays are tested for intersection with scene primitives to identify a first intersected primitive for each ray, if any.

After identifying an intersection for a given ray, a shader associated with that primitive determines what happens next. For example, if the primitive is part of a mirror, then a reflection ray is issued to determine whether light is hitting the intersected point from a luminaire, or in more complicated situations, subsurface reflection, and scattering can be modeled, which may cause issuance of different rays to be intersected tested. By further example, if a surface of an object were rough, not smooth, then a shader for that object may issue rays to model a diffuse reflection on that surface. As such, finding an intersection between a ray and a primitive is a first step in determining whether and what kind of light energy may reach a pixel by virtue of a given ray, since what light is hitting that primitive still has to be determined.

Thus, most conventional algorithms build a tree of rays in flight when raytracing a scene, where the tree continues along each branch until it leaves the scene or hits a luminaire that does not issue new rays. Then, for those branches that hit light emissive objects, the branches are rolled up through the primitive intersections, determining along the way what effect each primitive intersection has on the light that hits it. Finally, a color and intensity of light for the originally issued camera ray can be determined and stored in the buffer.

If raytracing is not managed well, however, it can be computationally intensive. Among the various available data structures that assist the raytracing process is the bounded (B)-KD (k dimensional) tree data structure, which is also the one best suited for hardware implementations. This structure is a combination of space partitioning KD tree structures and bounding volumes to surround the primitive. By using this tree structure, the best results from the raytracing can be achieved.

While raytracing has been implemented in both software and hardware over the recent years, significant amount of acceleration has been limited due to the requirement of high numbers of computational units and the complex nature of the traversal algorithm. Modifications to the algorithm and the hardware architecture configuration, however, make it possible to achieve a very high order of performance improvement. Such modifications in the algorithm and the associated hardware architecture are described in the present disclosure.

### FIGURES

FIG. 1 is a diagram illustrating a B-KD tree traversal algorithm.

FIGS. 2A-C illustrate various embodiments of a hybrid architecture that may be employed for accelerating the raytracing tree traversal algorithm where FIG. 2A is a diagram of one embodiment of a hybrid architecture employing a graphics processor unit (GPU) to implement a ray-triangle intersection algorithm, FIG. 2B is a diagram of one embodiment of a hybrid architecture employing a field programmable gate array (FPGA) to implement a ray-triangle intersection algorithm, and FIG. 2C is a diagram of one embodiment of a hybrid architecture employing a central processing unit (CPU) to implement a ray-triangle intersection algorithm.

FIGS. 3A-C illustrate block diagrams of various embodiments of field programmable gate array (FPGA) processor implementations of the tree traversal algorithm where FIG. 3A is a diagram of one embodiment of a FPGA implementation of the tree traversal algorithm comprising an on-chip block random access memory (BRAM), FIG. 3B is a diagram of another embodiment of a FPGA implementation of the tree traversal algorithm comprising both an on-chip and off-chip BRAM, and FIG. 3C is a diagram of yet another embodiment of a FPGA implementation of the tree traversal algorithm comprising an off-chip BRAM.

FIG. 4 is a diagram of one embodiment of a tree traversal PE core.

FIG. 5 illustrates a simple binary tree structure.

FIG. 6 is a diagram illustrating one embodiment of a result intersected node packing configuration of the results stack shown in the embodiment of FIG. 4.

FIG. 7 illustrates one embodiment of a data format for a 16 bit data storage structure.

FIG. 8 illustrates one embodiment of a technique of aggregating rays across independent renderer central processing unit (CPU) threads.

FIG. 9A illustrates tree traversal and object intersection stages in a ray tracing flow.

FIG. 9B illustrates a technique of traversal employing the coherency in traversal paths of FIG. 9A.

FIG. 10 illustrates one embodiment of ray-box filter to perform an intersection test of the box coordinates representing a leaf node with each ray in a beam.

FIG. 11 illustrates various embodiments of a bounding box.

FIG. 12 is one embodiment of an output of a ray-box filter implemented with a ray-beam input.

FIG. 13 illustrates one embodiment of a ray-box hardware design that can be architected to allow for multiple ray-box engine cores to be instantiated and tied to either the same or different external memory devices and appear as different ‘streams’ for usage by different software threads that can utilize them independently.

FIG. 14A illustrates a ray-tracing flow where each ray is processed one at a time going through traversal and intersections.

FIG. 14B illustrates a workflow that employs a list of bounding boxes obtained for each ray from the ray-box intersections stage in order to leverage early-exit so as to avoid doing unnecessary primitive object intersection calculations.

FIG. 15 illustrates one embodiment of a computing environment.

### DESCRIPTION

The following description is presented to enable a person of ordinary skill in the art to make and use various aspects of the disclosed embodiments. The various embodiments disclosed in the present specification are directed generally to apparatuses, systems, and methods for accelerating raytracing computations using various techniques. Numerous specific details are set forth to provide a thorough understanding of the overall structure, function, manufacture, and use of the disclosed embodiments as described in the specification and illustrated in the accompanying drawings. It will be understood by those skilled in the art, however, that the disclosed embodiments may be practiced without the specific details disclosed herein. In other instances, well-known operations, components, and elements have not been described in detail in the interest of conciseness and clarity and so as not to obscure the disclosed embodiments. Various modifications to the embodiments described herein may be apparent to those skilled in the art, and the general principles defined herein may be applied to other embodiments and applications without departing from the scope of the disclosed embodiments. Those of ordinary skill in the art will understand that the disclosed embodiments describing specific techniques, implementations, and applications are provided for illustrative purposes only and serve as non-limiting examples. Thus, it can be appreciated that the specific structural and functional details disclosed herein are representative in nature and are not necessarily limiting. Rather, the overall scope of the embodiments is defined solely by the appended claims.

Reference throughout the specification to “various embodiments,” “some embodiments,” “one embodiment,” or “an embodiment” means that a particular feature, structure, or functional characteristic described in connection with a disclosed embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, particular features, structures, and/or functional characteristics associated with one embodiment may be readily combined in any suitable manner with one or more than one embodiment, without limitation. Thus, the particular features, structures, or functional characteristics illustrated or described in connection with one embodiment may be combined, in whole or in part, with the features structures, or characteristics of one or more than one other embodiment, without limitation.

It will be appreciated that for the sake of conciseness and clarity in description, data for a certain type of object, e.g., a primitive (e.g., coordinates for three vertices of a triangle) usually are described simply as the object itself, rather than referring to the data for the object. For example, when referring to “a ray,” it is to be understood that data representative of that ray is referenced, as well as the concept of the ray in the scene. Similarly, for example, when referring to “a tree,” it is to be understood that data representative of the tree structure is referenced. In addition, the use of “logic” herein should be understood to mean that the logic function can be implemented as either an algorithm, digital signal processing routine, or a logic circuit (such as that implemented on a field programmable gate array).

Various embodiments disclosed in the present specification are directed generally to techniques for accelerating raytracing computations using various hardware architectures and techniques. In one embodiment, field programmable gate array (FPGA) processors are used for accelerating the computations associated with raytracing. Several implementations of such embodiments described herein include, but are not limited to, the following implementations, substantially as disclosed and described herein in any combination thereof:
(1). A tree traversal technique, architecture, and hardware implementation therefor substantially as disclosed and described;
(2). A hybrid central processing unit (CPU)-graphics processor unit (GPU)-field programmable gate array (FPGA) configuration to implement raytracing techniques substantially as disclosed and described;
(3). A depth-breadth search tree tracing technique substantially as disclosed and described;
(4). A blocking tree branch traversal technique to avoid data explosion substantially as disclosed and described;
(5). Compact data structure representation for ray and node representation substantially as disclosed and described; and/or
(6). Multiplexed processing of multiple rays in a programming element (PE) to leverage pipeline bubble.

Compared to linear data structures, e.g., linked lists and one dimensional arrays, which have only one logical means of traversal, tree structures can be traversed in many different ways. Starting at a root node of a binary tree, there are three main steps that can be performed and the order in which these steps are performed defines the traversal type. These steps include, for example, performing an action on the current node (referred to as “visiting” the node), traversing to the left child node, and traversing to the right child node. Thus the process is most easily described through recursion.

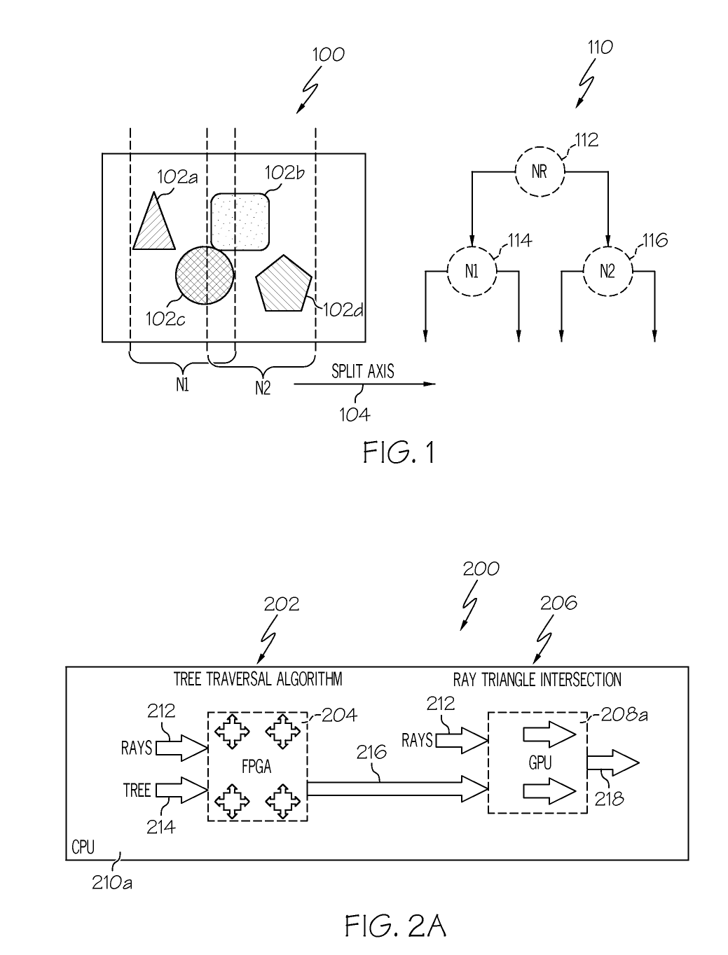

FIG. 1 is a diagram illustrating a B-KD tree traversal algorithm. FIG. 1 illustrates a 2D space 100 containing several objects 102a, 102b, 102c, 102d. The KD tree traversal algorithm recursively splits the space 100 through the choice of a split axis 104 aligned with the splitting plane. The resulting KD-tree 110 is shown to the right of the 2D space 100 in FIG. 1. The KD-tree includes a tree node 112 (NR) and two child nodes 114, 116 (N1, N2). In one embodiment, a tree traversal algorithm divide the tree node 112 space into two subsets, children nodes 114, 116, and holds the two intervals along the splitting axis 104. The space 100 is recursively subdivided until there are a set number of primitives (triangles) per node. Only a single axis is considered in each node, instead of storing the entire bounding volume. The first top node is called the root node which is basically the whole space itself. The node that finally contains a set number of primitives is called the leaf node.

In one embodiment, a basic tree traversal flow comprises testing a ray for intersection with the nodes N1, N2 defined by the intersecting intervals. The path of the traversal depends on the intersection test. If the intersection test is positive, then two intersection intervals are calculated. These two intersection intervals are used for comparison to the child nodes. This is a recursive traversal function that traverses through all the nodes of the entire tree 110. This is done on a per node basis following an algorithmic flow. This algorithm does not push a node and its intersection intervals onto a stack.

Accordingly, the above raytracing algorithm, is substantially different from conventional raytracing algorithms that perform the intersection test for the child nodes when traversing the parent node and subsequently push one of the node and its intersection intervals onto a stack. This takes away resources and the control logic to manage the levels. Also, the raytracing algorithm in accordance with the disclosed embodiments can be implemented irrespective of the direction of the ray being traced, which is not the case in software implementations where the early termination test is performed before proceeding further with the traversal. In a hybrid raytracing implementation in accordance with the disclosed embodiments, the tree traversal algorithm may be implemented with a FPGA processor.

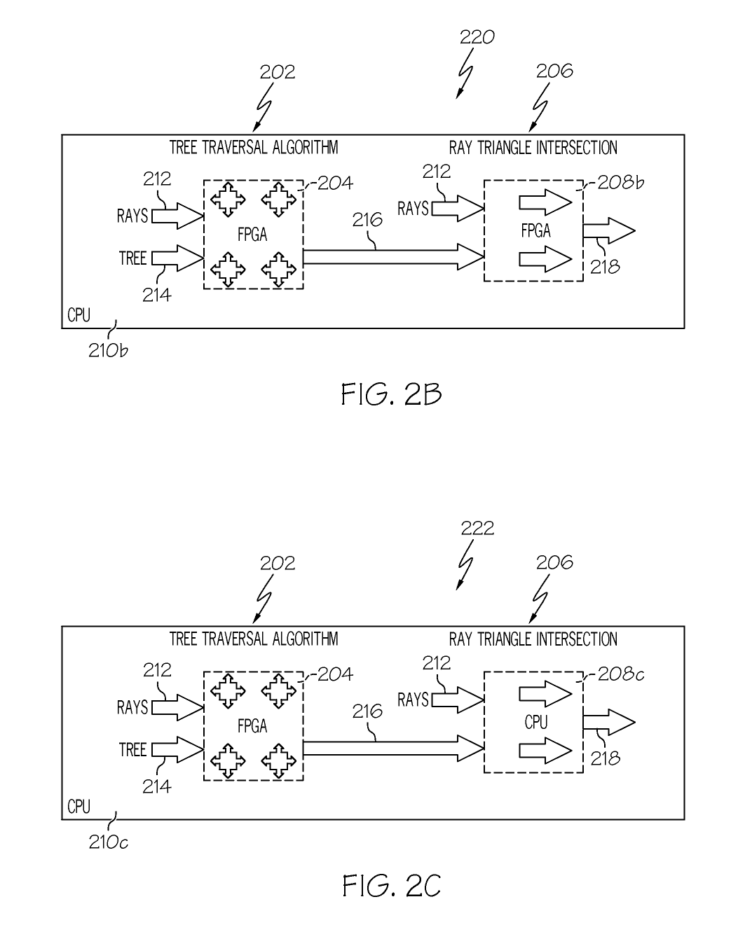

FIGS. 2A-C illustrate various embodiments of a hybrid architecture that may be employed for accelerating the raytracing tree traversal algorithm. FIG. 2A is a diagram illustrating one embodiment of a hybrid architecture 200 that may be employed for accelerating the raytracing tree traversal algorithm. In one embodiment, the hybrid architecture 200 for the raytracing tree traversal algorithm comprises two portions: (1) a tree traversal algorithm 202 portion implemented with an FPGA 204 processor and (2) a ray-triangle intersection algorithm 206 portion implemented with a graphics processor unit 208a (GPU). The operation of the FPGA 204 processor and the GPU 208a is controlled by a central processing unit 210a (CPU). Data representative of rays 212 is provided to the FPGA 204 processor and the GPU 208a. Input node data 214 representative of the tree structure is provided to the FPGA 204 processor. The FPGA 204 processor executes the tree traversal algorithm 202 in accordance with the disclosed embodiments and outputs a data stream 216 representative of triangles to the GPU 208a.

In one embodiment, the hybrid architecture 200 enables the FPGA 204 processor and the GPU 208a to fully utilize their respective processing and the computational power independently, and together achieve high performance. In one embodiment, although somewhat limited by the ability to access random data, the GPU 208a is able to achieve high floating point computational density. The hybrid architecture 200 is well suited for the ray-triangle implementation where the data stream 216 associated with the triangles is streamed to the GPU 208a, which executes the triangle intersection algorithm 206, and then streams out the triangle intersection data 218. In various embodiments, random access of data is generally not required and the processing can be based on a set of floating point computations.

In one embodiment, the tree traversal algorithm 202 can be better suited for the FPGA 204 process where the node data 214 associated with the tree structure can be stored partly in a block random access memory (BRAM) and provided to the FPGA 204 processor or on a large, high speed static RAM (SRAM) interfaced with the FPGA 204, for example. By replicating multiple tree traversal cores or programming element (PE) cores on the FPGA 204 processor, a processing power superior to a single core CPU or quad core CPU with the same algorithm can be achieved.

In one embodiment, the CPU 210a is configured for performing tree building, data packing, and interfacing functions for the FPGA 204 processor and the GPU 208a. The combination of the CPU 210a, the FPGA 204, and the GPU 208a provides faster raytracing.

In one embodiment, the FPGA 204 processor can be implemented with an FPGA embedded processor such as, for example, a Xilinx Virtex or Spartan series FPGA device available from Xilinx, Inc. of San Jose, Calif.; the GPU 208a can be implemented with an Nvidia GeForce series GPU device available from Nvidia of Santa Clara, Calif.; and the CPU 210 can be implemented with an Intel Xeon multi-core processor device available from Intel Corp. of Santa Clara, Calif. Those skilled in the art will appreciate that the FPGA 204 processor, the GPU 208a, and/or the CPU 210 may be readily substituted with one or more than one functionally equivalent component(s) without limiting the scope of the disclosed embodiments. For example, functional components may be substituted without limiting the scope of the hybrid architecture 200.

FIG. 2B is a diagram of one embodiment of a hybrid architecture 220 employing a FPGA 208b to implement the ray-triangle intersection algorithm 206. The operation of the FPGA 204 processor and the FPGA 208b is controlled by a CPU 210b. In other respects, the hybrid architecture 220 functions in a manner similar to the hybrid architecture 200 described in reference to FIG. 2A.

FIG. 2C is a diagram of one embodiment of a hybrid architecture 222 employing a CPU 208c to implement the ray-triangle intersection algorithm 206. The operation of the FPGA 204 processor and the CPU 208c is controlled by a CPU 210c. In other respects, the hybrid architecture 222 functions in a manner similar to the hybrid architectures 200, 220 described in reference to FIGS. 2A and 2B.

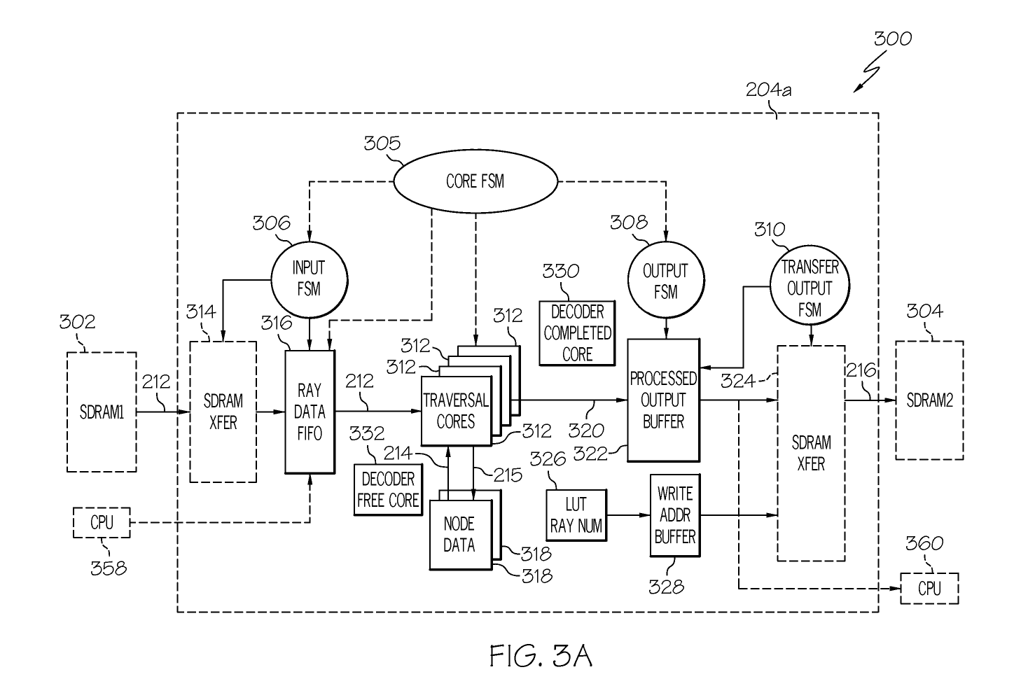

FIGS. 3A-C illustrate block diagrams of various embodiments of FPGA implementations of the tree traversal algorithm 202. In various embodiments, one or more than one FPGA processor can be used for a particular implementation. FIG. 3A is a diagram 300 of one embodiment of a FPGA 204a processor implementation of the tree traversal algorithm 202. The FPGA 204a processor described in FIG. 3A is one embodiment of the FPGA 204 processor of the hybrid architecture 200 shown in FIG. 2. In one embodiment, the FPGA 204a processor comprises a core finite state machine 305 (FSM), input FSM 306, output FSM 308, transfer output FSM 310, one or more than one processing element (PE) core 312, e.g., traversal core(s), various buffers 316, 322, SDRAM transfer components 314, 324, and one or more than one block RAM 318. Other functional blocks provide the interface and control logic for processing the ray data 212 input into the FPGA 204a processor. The core FSM 305 controls the input FSM 306, the output FSM 308, and the transfer output FSM 310. The core FSM 305 also controls the PE cores 312. In one embodiment, the ray data 212 may be received by the FPGA 204a processor from a first (input) serial dynamic RAM 302 (SDRAM). In one embodiment, the processed data stream 216 representative of triangles may be output by the FPGA 204a processor and is provided to a second (output) SDRAM 304. The PE cores 312 form the basic core computation logic of the FPGA 204a processor for executing the tree traversal algorithm 202. In various embodiments, up to sixteen separate PE cores 312 may be employed to execute the tree traversal algorithm 202. In various embodiments eight to sixteen separate PE cores 312 may be employed to execute the tree traversal algorithm 202. It will be appreciated, however, that a particular implementation may employ any number of PE cores 312 greater than or fewer than sixteen, for example.

Under control of the input FSM 306, the ray data 212 is transferred from the first (input) SDRAM 302 to an SDRAM transfer block 314 and to a ray data first-in-first-out (FIFO) register 316. The ray data 212 (RAY IN) are provided as input to one or more than one of the PE cores 312 for processing the tree traversal algorithm. The input node data 214 (NODE IN) associated with the tree structure are stored in one or more than one BRAM 318 and may be transferred to the PE core 312 from the BRAM 318. Similarly, output node data 215 (NODE OUT) are provided from the PE core 312 and are stored in the BRAM 318. In the illustrated embodiment, the BRAM 318 is an on-chip BRAM integrated with the FPGA 204a processor die. As used herein, on-chip refers to a BRAM provided on the FPGA 204a processor whereas off-chip refers to a BRAM located separately from the FPGA 204a processor. The PE core 312 processes the ray data 212 and the node data 214 and outputs the processed data 320 (INT NODE OUT) via a processed output buffer 322 to an SDRAM transfer 324 block to the second (output) SDRAM 304. The PE core 312 also outputs the processed node data 215 to the BRAM 318.

The output FSM 308 controls the processed output buffer 322 and the transfer output FSM 310 controls the transfer of data from the processed output buffer 322 to the SDRAM transfer block 324. The data stream 216 representative of triangles is provided to the second (output) SDRAM 304.

A look-up table 326 (LUT) indexes the ray number in a write address buffer 328. The LUT 326 controls the transfer of the data stream 216 from the SDRAM transfer block 324 to the second (output) SDRAM 304.

Various decoders 330, 332, among other functional logic blocks, provide the interface and control logic necessary for the processing the ray data 214, routing the node input/output data 214/215, the processed data 320, and the stream data 216.

FIG. 3B is a diagram 350 of one embodiment of a FPGA 204b processor implementation of the tree traversal algorithm 202. The FPGA 204b processor described in FIG. 3B is one embodiment of the FPGA 204 of the hybrid architecture 200 shown in FIG. 2. The FPGA 204b processor architecture and functionality is generally similar to the FPGA 204a shown in FIG. 3A with the exception that the node data representative of the tree structure may be stored in an off-chip memory 352 such as SRAM or DRAM as well as on on-chip BRAM 318. In embodiments employing external memory 352 resources, a memory controller 356 is provided onboard the FPGA 204b processor to access the external memory 352. In the illustrated embodiment, the PE core 312 can receive the node data 214, 354 (NODE IN) associated with the tree structure from the on-chip BRAM 318 and/or the off-chip memory 352. Similarly, the PE core 312 can write the node output data 215, 355 (NODE OUT) to the on-chip BRAM 318 and/or the off-chip memory 352.

FIG. 3C is a diagram 360 of one embodiment of a FPGA 204c processor implementation of the tree traversal algorithm 202. The FPGA 204c processor described in FIG. 3C is one embodiment of the FPGA 204 of the hybrid architecture 200 shown in FIG. 2. The FPGA 204c processor architecture and functionality is generally similar to the FPGA 204a shown in FIG. 3A with the exception that the node data representative of the tree structure is stored only in an off-chip memory 362 such as a SRAM or DRAM. In embodiments employing external memory 362 resources, a memory controller 356 is provided onboard the FPGA 204c processor to access the external memory 362. In the illustrated embodiment, the PE core 312 receives the node data 364 (NODE IN) associated with the tree structure from the off-chip memory 362. Similarly, the PE core 312 writes the node output data 365 (NODE OUT) to the off-chip memory 362.

In the various embodiments of the FPGA 204a, b, c processors shown in respective FIGS. 3A-C, the ray data 212 may be transferred into and out of the FPGA 204a, b, c processors using a data streaming model. Accordingly, in a data streaming model the RAM 302, 304 and the SDRAM transfer components 314, 324 may be replaced respective CPUs 358, 360 where the ray data 212 is streamed directly into the FPGA 204a, b, c processors from the CPU 358 and is streamed out of the FPGA 204a, b, c processors to CPU 360. In one embodiment, the streamed data may be temporarily stored in an onboard memory such as a SRAM or DRAM (not shown) for batch processing.

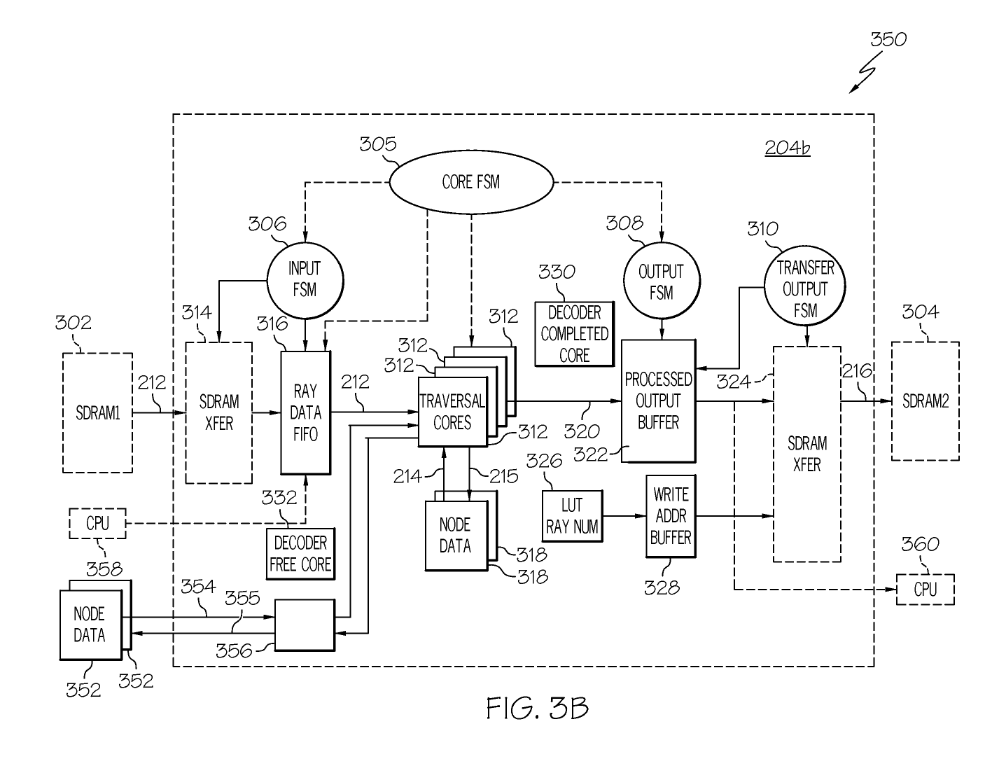

FIG. 4 is a diagram 400 of one embodiment of the tree traversal PE core 312. In one embodiment, the tree traversal PE core 312 comprises one or more than one floating point computation blocks, control logic, and storage elements for effectively carrying out the node intersection processing algorithm (intersection with the rays).

In one embodiment, a PE core 312 may comprise one or more than one core floating point computations block 402 to execute the floating point computations required by the ray tracing algorithm. In one embodiment, a floating point computations block 402 may comprise one or more than one floating point subtractor (S1, S2), multiplier (M1, M2), and comparator (C3, C4, C5, C6) blocks. In one embodiment, one or more than storage memories comprising a primary storage 406, a secondary storage 408, and an intermediate storage 410 for storing intermediate values can be provided in a feedback path 404. In the illustrated embodiment, the primary storage 406 is implemented as a primary queue FIFO register and the secondary storage 408 is implemented as a secondary queue stack FILO (first-in-last-out) register. In the illustrated embodiment, the storage 410 for the intermediate value is implemented as a three separate FIFO registers. The input ray data 212 is provided to an input register 412 and then to the core floating point computations block 402. A FIFO storage register 414 is provided to store the input node data 214 and a FIFO storage register 416 is provided to store the output node data 215. The working of the PE core 312 and its blocks are explained in detail in the following sections.

In one embodiment, a first decision block 418 determines whether a ray has passed through a node of the tree. If “yes,” the output is a leaf node and a leaf node value 420 is stored in a results stack 422 (e.g., Stack 1, Stack 2). From the results stack 422, the processed data 320 (INT NODE OUT) is provided to the processed output buffer 322 (FIG. 3A). If the output of decision block 418 is “no,” e.g., the ray has not passed through a node of the tree, the flow proceeds along the feedback path 404. A second decision block 424 in the feedback path 404 determines whether the primary FIFO storage 406 is empty. If “yes,” e.g., storage space is still available in the primary storage 406, the intermediate node data is stored in the primary storage 406, otherwise the intermediate node data is stored in the secondary storage 408. In one embodiment, the primary storage 406 and the secondary storage 408 in the feedback path 404 may be filled in accordance with a predetermined process. In one embodiment, the first decision block 418 performs two tasks. Primarily the first decision block 418 performs an intersection test and when the intersection is true, then the first decision block 418 checks to see if it is a leaf node, and only if it is a leaf node, the leaf node value 420 is stored in the result stack 422. If the intersected node is not a leaf node, then the two child nodes under it in the tree are loaded into the primary storage 406 and, when the primary storage 406 is full, it overflows into the secondary storage 408.

The core floating point computations block 402 of the PE core 312 performs the intersection test on one particular node and derives the intervals for the tests on the child nodes. This test can be mathematically expressed as a sequence of computations shown below.

S1=BOUND[RAY_SIGN[Axis]]−FROM[Axis]

S2=BOUND[1−RAY_SIGN[Axis]]−FROM[Axis]

M1=S1×RAYDIR_INV[Axis]=Lower Adist (L.A.)

M2=S2×RAYDIR_INV[Axis]=Upper Adist (U.A.)
If ((L.A.<=Far Adist) and (U.A.>=Near Adist)) then Intersecting, and

Near Adist=max (Near Adist, L.A.),

Far Adist=min (Far Adist, U.A).

In one embodiment, set of floating point computations discussed above can be implemented in an FPGA processor (e.g., FPGA processor 204a-c shown in FIGS. 3A-C) by using and carefully mapping FPGA IP cores (e.g., Xilinx IP cores where IP stands for “Intellectual Property”) that are available to use and which gives the optimum performance for resources used. These IP (Floating Point cores) can be configured to operate at the required speed and latency levels, as desired by the architecture. Those skilled in the art will appreciate that Xilinx offers multiple parameter-driven digital signal processor (DSP) and general-purpose LogiCORE™ modules optimized with Xilinx Smart-IP Technology for predictable, consistent performance that is unaffected by FPGA density and surrounding logic. These LogiCORE products include memory compilers, asynchronous dual-port FIFOs, high-performance multipliers, and finite impulse response (FIR) filters. Such modules can be downloaded over the Internet from the Xilinx IP-Center and configure them with the Xilinx CORE Generator. In addition, Xilinx offers a range of reference configurations provided as hardware description language (HDL) source code. The description of each of these Xilinx IP cores is incorporated herein by reference in its entirety.

As discussed previously, the ray data 212 are tested for intersection with scene primitives to identify a first intersected primitive for each ray. The ray-triangle intersection algorithm 206 (FIG. 2A-C), as implemented on the GPU 208a (FIG. 2A), FPGA 208b (FIG. 2B), or CPU 208c (FIG. 2C), and the delays in fetching and latching the ray data 212, causes a total latency of about 20 clock cycles. This is a significant latency penalty for each intersection test. Accordingly, if an intersection test were to be executed on every node, the effective performance would be one ray node intersection per every 20 clock cycles. The latency in the processing is caused by the IP floating point cores (e.g., Xilinx floating point cores) all put together and in accessing the node details in case the node data is stored off chip. To handle the latency and the bubble, the present disclosure provides various embodiments as described in more detail below. To overcome the recurring latency, both the child nodes are processed in succession, which to some extent follows the breadth of the first flow. Nevertheless, by having two storage elements, e.g., the primary storage 406 (FIFO) and the secondary storage 408 (FILO or stack), a partial depth first search flow is established to avoid data explosion as described in more detail below. In one embodiment, multiple rays are streamed in to overcome the initial latency (even with having both the child nodes) and the bubbles that would be otherwise created suppose a child node does not pass intersection rest as described in more detail below.

In one embodiment, the performance drop due to the latency can be overcome by the novel architecture shown in FIG. 4 in which the PE core 312 are configured. The nodes of the tree are processed in an order in which the tree is traversed. In various embodiments, the new PE core 312 architecture provides brings additional points of novelty, including, for example: (1) depth-breadth search tree traversal; and tree blocking to avoid data explosion.

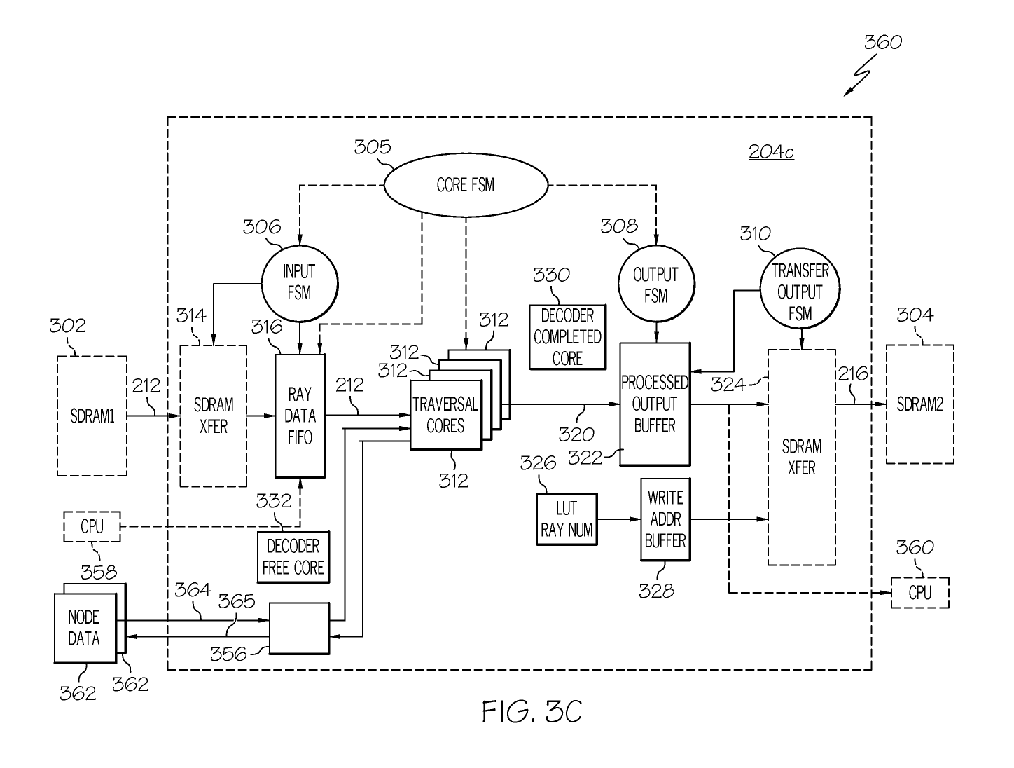

The depth-breadth search tree traversal and the tree blocking to avoid data explosion concepts can be illustrated in conjunction with FIG. 5, which illustrates a simple binary tree structure 500. Consider, for example, the illustrated tree structure 500 and the numbering of the nodes (NODES 1-20 in FIG. 5). In a conventional KD tree traversal or a B-KD tree traversal, after processing the parent node (NODE 1), one child node is pushed onto a stack, and only one child node is processed in a recursive manner. In a depth first search tree traversal, the preference is given to the control moving down in the direction of arrow 512 the tree structure 500 towards the leaf nodes. As previously discussed, the node that finally contains the set number of primitives is called the leaf node. For example, with reference back to FIG. 4, the leaf node value 420 is stored in the results stack 422 (Stack1 and/or Stack 2). With reference now back to the tree structure 500 of FIG. 5, the control flow or the order in which nodes are processed (considering all nodes intersecting) is: 1, 2, 3, 4, 5, 6, 7, 8, 9, 10, 11, 12, 13, 14, 15, 16, 17, 18, 19, 20—one at a time, every Iteration taking 20 clock cycles.

In a conventional software implementation of the tree traversal algorithm, the nodes in the tree structure 500 shown in FIG. 5, may be processed as follows:
Iteration 1: Node 1;
Iteration 2: Node 2, 14 Stack 15, 16; and
Iteration 3: Node 3, 8 Stack 15, 16, 9, 12.

Those skilled in the art will appreciate that this kind of control is best suited for software implementations and for the early termination of the tree traversal algorithm. In a hardware implementation according to the disclosed embodiments, however, this method of computing is inefficient and computation resources may remain idle and may have high latency as mentioned previously. In various hardware implementations, for example, one ray node intersection per clock cycle may be desired and provides the best possible performance. In one embodiment, this may be addressed by a two step improvement in the pipeline architecture by (1) pipelining more nodes and (2) pipelining more rays.

In one embodiment, as many nodes as available in the pipeline are processed at a particular time instead of pushing them onto a stack for later processing. In the embodiment illustrated in FIG. 4, this can be implemented with two storage elements—the primary storage 406 and the secondary storage 408, for example. Upon completion of a ray node intersection test, the identifiers (IDs) of the next consecutive child nodes are loaded into the primary storage 406 (e.g., a simple FIFO as shown in FIG. 4), which is addressed first, in preference to the secondary storage 408, and the data for the required node are immediately fetched for processing. For the best case scenario, this process continues as illustrated in the tree structure 500 of FIG. 5, where all nodes are intersected as follows:
Iteration 1: Node 1 along path 502;
Iteration 2: Node 2, 14 along path 504;
Iteration 3: Node 3, 8, 15, 16 along path 506;
Iteration 4: Node 4, 7, 9, 12, 17, 19 along path 508;
Iteration 5: Node 5, 6, 10, 11, 13, 18, 20 along path 510 and so on.

The number of nodes that can be processed in this manner increases exponentially and reaches a point where the pipeline becomes full. The maximum number of nodes that can be processed at any given point of time may be equal to the length of the pipeline. This to some extent follows the breadth first search traversal. When the number of nodes exceeds the length of the pipeline, the subsequent nodes are stored away in the secondary storage 408 (FIG. 4). At this point the traversal shifts to behave as a depth first search traversal. The secondary storage 408 is only addressed when the primary storage 406 is not full, e.g., still empty as determined by decision block 424, indicating the presence of idle stages in the pipeline. In this manner, by combining the two approaches, the depth breadth search traversal ensures the full utilization of the resources of the FPGA 204a processor and eliminates idle stages completely.

Maintaining the secondary storage 408 (FIG. 4) as a simple FIFO would result in it being extremely large, which is a limitation of the FPGA processor. In one embodiment, the need for a very large secondary storage 408 can be addressed by making the secondary storage 408 a stack (which follows a LIFO model), as shown in FIG. 4. Thus as the tree structure 500 (FIG. 5) is traversed from top to the bottom in the direction indicated by arrow 512, higher level nodes are pushed in the stack 408 first and are retrieved last. Accordingly, the need for a very large secondary storage 408 is greatly reduced and avoids a possible data explosion.

Careful analysis of the timing and pipeline data reveals whether there exist bubbles of idle states. Bubbles of idle states exist due to the fact that initially, the number of nodes required to fill the pipeline are actually available only after processing the root node (e.g., Iteration 1: Node 1 along path 502 in FIG. 5) and next two nodes (Iteration 2: Node 2, 14 along path 504 along path 504 in FIG. 5) and so on. This process provides the best case condition for the pipeline to be full. In cases where there are no intersections, the pipeline tends to have gaps. To address these issues, in one embodiment, the PE cores 312 (FIGS. 3A-C, 4) can be configured to handle multiple rays. For example, the PE cores 312 can be configured such that they can handle rays 4, 8, or 16 (FIG. 5) at a given instance. The dependencies of the tree 500 (FIG. 5) on the ray are eliminated by using flip flops and storage memory to feed back the required node details and intervals, and by adapting the tree traversal algorithm the dependency on the level can be reduced, minimized, and/or eliminated. Accordingly, the processing can be executed irrespective of the level and is subjective to nothing other than the node particulars. Following is an illustration for a multi-ray timeline for four (4) rays pipelined.
Iteration 1: (R1 N1), (R2 N1), (R3 N1), (R4 N1)
Iteration 2: (R1 N2), (R1 N14), (R2 N2) (R2, N14), (R3 N2), (R3 N14), (R4 . . .
Iteration 3: (R1 N3), (R1 N8), (R1 N15), (R1 N16), (R2 . . .

When compared to conventional software implementations or to hardware implementations without a multi-ray architecture, it can be shown that the PE cores 312 (FIGS. 3A-C. FIG. 4) are better utilized and thus better pipelined. In one embodiment, this process provides that idle bubbles in the initial state of the pipeline can be reduced, minimized, and/or eliminated to achieve one ray node intersection for every clock cycle.

To accommodate the multiple rays, flip-flops and storage elements can be used to pipeline and feedback the ray IDs respective to the particular node. All other ray data can be stored as registers in an array and retrieved immediately as and when required, and based on the node details (e.g., node axis). The cost for the performance improvement is very little—resources for the storage of the rays.

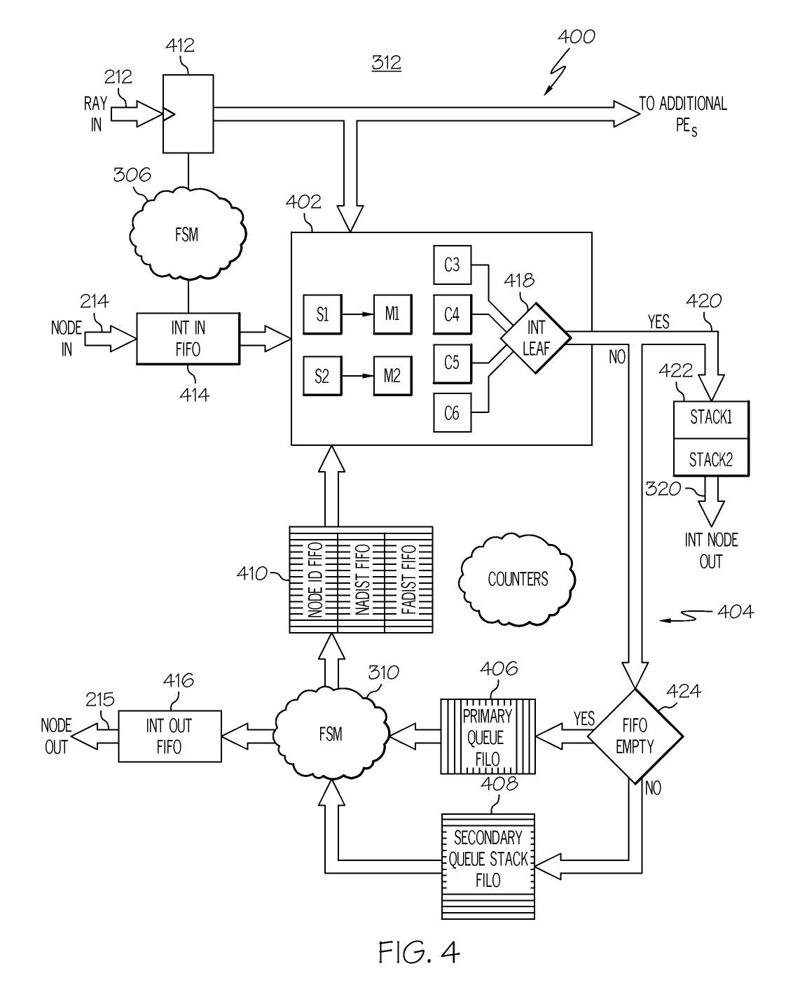

With reference now back to FIG. 4, the intersection test described above is carried out for every node and if the ray intersects the node, the intervals (e.g., Near Adist and Far Adist) that are calculated by the PE core 312 floating point computations block 402 are stored in the FIFO registers 410 in the feedback path 404 and retrieved later for the intersection tests of the child nodes. If the node intersected is a leaf node 420, however, the leaf node 420 ID is stored in an output Block RAM—the result stack 422, which will be read at the end of the tree traversal algorithm. It is also packed with the Ray_ID and count for reference to the CPU 210 (FIG. 2) as shown in FIG. 6, which is a diagram 600 illustrating one embodiment of a result intersected node packing configuration of the results stack 422 shown in the embodiment of FIG. 4.

The data required for the Intersection test by the FPGA 204 (FIG. 2) is substantially lower than the raytracing in CPU 210, because of the difference of this implementation as explained in the earlier section, which comprises, for example:
(1) Node data: Lower Bound, Upper Bound, Next_node_address/Leaf node ID, Node Axis, Leaf Node), which is stored in the SRAM; and
(2) Ray Data: Raydir, Raydir_inv, Ray_sign and the source from—in all three dimensions.

With reference now to FIGS. 3A-C and FIG. 4, in one embodiment, the data packing can be performed in such a way that minimum space is utilized and maximum bandwidth and density is achieved during data transfer and storage. Depending on the precision of the desired PE core 312, the size of the data values can be 16 bits, 24 bits, or 32 bits, or any suitable number of bits, without limitation.

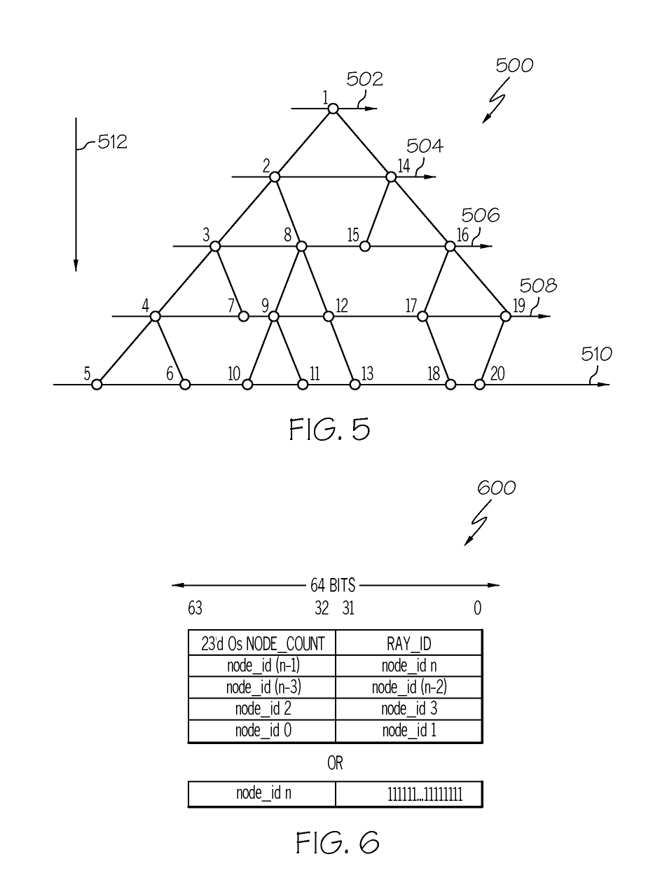

An example data format for a 16 bit data storage structure 700 is shown in FIG. 7. With reference now to FIGS. 3A-C, FIG. 4, FIG. 5, and FIG. 7, in one embodiment, the node details can be stored in the memory as a look up table 326, where they are stored in locations respective to their position in the tree structure 500. The node details may include a next node address which is loaded into the PE core 312 if the particular parent node fails the intersection test, the next node address is obtained by just incrementing the node address, that is being processed, by one and access the respective location in the memory. The representation of the ray data 212 takes up more space as it is represented in all three dimensions. Certain logic for a divider can be eliminated by directly obtaining the inverse ray direction from the input. The ray sign can also be deduced by just reading the most significant bit (MSB) of this inverse and thus eliminating the transfer of ray direction as a separate data.

A typical software renderer cast rays in packets that may range in size from a single ray to 128 rays, for example. In a large scene with many such small packets of rays, performing computations on a co-processor may not be very efficient as it requires many software function calls to exchange small amounts of input/output data with the co-processor each time.

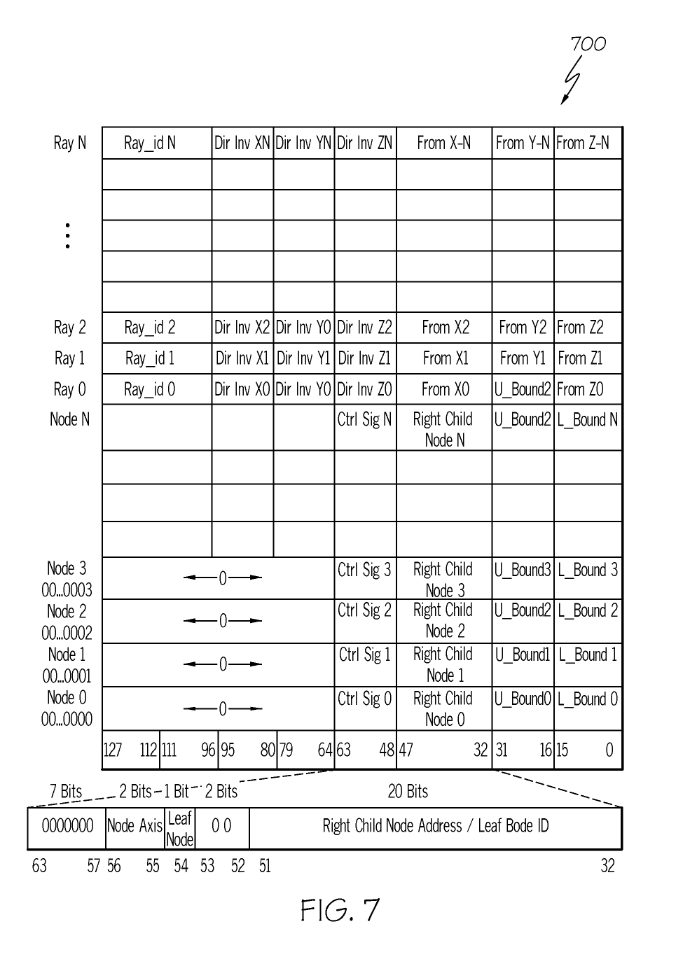

With reference to FIG. 8, in one embodiment, a technique of aggregating rays across independent renderer CPU threads is shown. Each independent renderer CPU thread 804 contains a smaller packet of rays. This allows coherency of rays to be maintained within packets, while a single larger ray bundle consisting of many such small ray packets is sent to the co-processor in a single software function call. In operation, the software renderer 802 starts multiple threads, each with their own packet of rays. Software locking mechanisms allow each thread to line up its packet of rays into an input buffer 806. Upon reaching a predetermined size, for example four threads, or once no more software renderer threads are available, the last thread, in this case RayPacket 4, triggers the input buffer 806 to transfer the entire buffer to FPGA X. FPGA X processes each ray packet independently, and transfers the result to an output buffer 808. Each of the RayPackets 1-4 contains its own set of rays and corresponding results, so each thread immediately continues with its own independent downstream processes after the results are ready.

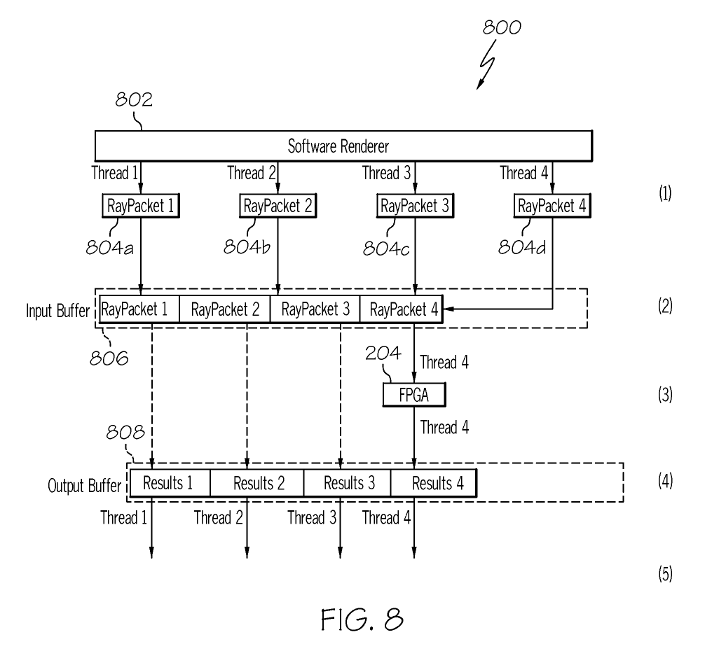

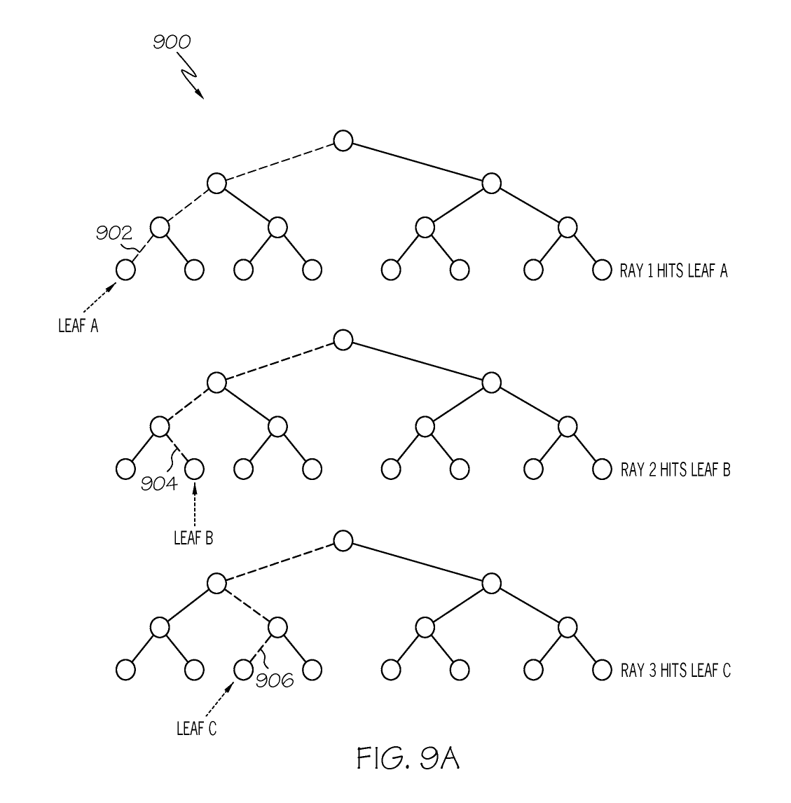

In a ray tracing flow, shown in FIG. 9A, there are two major stages, tree traversal and object intersection. Each ray would typically traverse through the tree until it hits a leaf-node, following which the ray-object intersections are computer for all primitive objects in that leaf. In the case where the packet of rays from the software renderer are mostly coherent, most of the rays would follow a similar path through the tree structure with minor differences in branching toward the deeper part of the tree.

FIG. 9B illustrates a technique of traversal employing the coherency in traversal paths of FIG. 9A. In one embodiment, a packet of coherent rays is shown as a beam of rays 908. Traversing the beam 908 by using rays 902 and 906, located at the bounds of the beam, to guide the traversal path, instead of doing so for each and every ray in the packet, produces a large reduction in traversal time and computation requirements, at the expense of more leafs being included in the hit results. The output of leafs hit for such a ray-beam traversal is effectively a union set of leafs that would be hit by each of the rays in the beam if they were traversed independently.

With reference now to both FIGS. 9A and 9B, in one embodiment the beam method is used to limit the processing required the traversal path of a three-ray beam. In the traditional method, shown in FIG. 9A, the rays 902, 904, and 906 each traverse the tree and produce a hit result of leafs A, B, and C. In a beam traversal, as shown in FIG. 9B, the rays 902 and 906 are designated as the boundary rays and used to traverse the outer bounds of the beam, producing hit results of leafs A, B, and C. Although a three-ray beam is shown, it will be understood by one skilled in the art that a beam can be composed of any number of rays with some level of coherency.

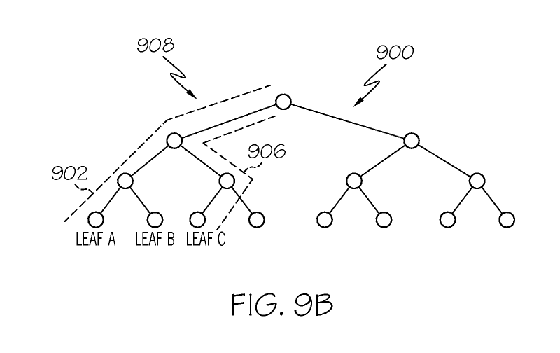

When the ray-beam traversal is performed, each ray-beam will produce a list of leafs hit. This leaf list applies to every ray in the beam, therefore each ray needs to have an intersection test done with all the primitive objects in every leaf node of that output list, which can be very computationally expensive and may produce false positive leaf hits for certain rays. In one embodiment, a ray-box intersection test stage can be implemented to filter the ray-beam output. Each leaf node can be represented by a bounding-box in all three dimensions (X, Y and Z coordinates). In one embodiment, shown in FIG. 10, the ray-box filter 1054 performs an intersection test of the box coordinates representing the leaf node with each ray in the beam. Each ray can be assigned a subset of the beam leaf hit list, consisting of only the specific leafs the particular ray actually hits, removing all false-positive hits produced by the beam traversal stage. The implementation of a ray-box filter stage would therefore reduce the number of primitive objects each ray would have to be intersected with to obtain a final output.

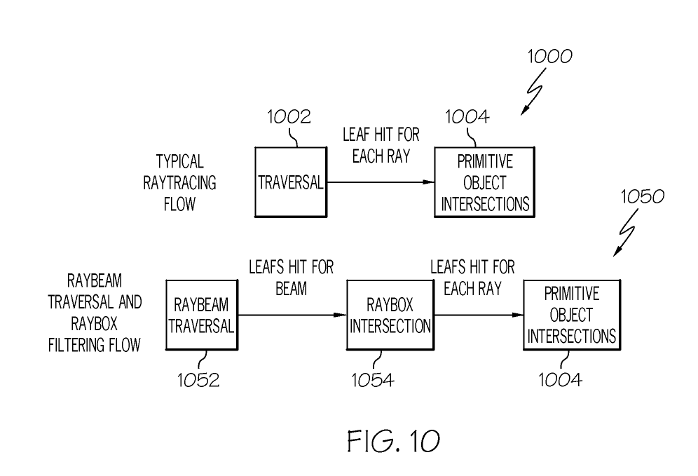

Various embodiments of a bounding-box are shown in FIG. 11. In one embodiment, the ray-box implementation, each of the input rays is compared to each of the bounding-boxes generated by the ray-box filter. This direct comparison generates a large amount of memory access to fetch each bounding box that needs to be computed for each ray input. In addition, this will generate large amounts of output due to the need for each intersection test to generate a result of ‘hit’ or ‘no-hit’, and in the case of a ‘hit’, the distance value is generated.

For maximum hardware performance, both memory access and output amount have to be reduced as far as possible. In one embodiment, an optimized ray box hardware 1150 allows for the reduction in memory access and output to be achieved by taking a ray-beam as an input to the ray-box filter. Since every ray-beam output has a set of rays and a set of bounding boxes, for which an “all-against-all” computation has to be done, this lends itself well to a hardware design where a group of rays is taken in, an only a single bounding-box fetch has to be done at a time for computation against all rays in a ray-beam. This significantly reduces memory accesses to fetch the bounding boxes.

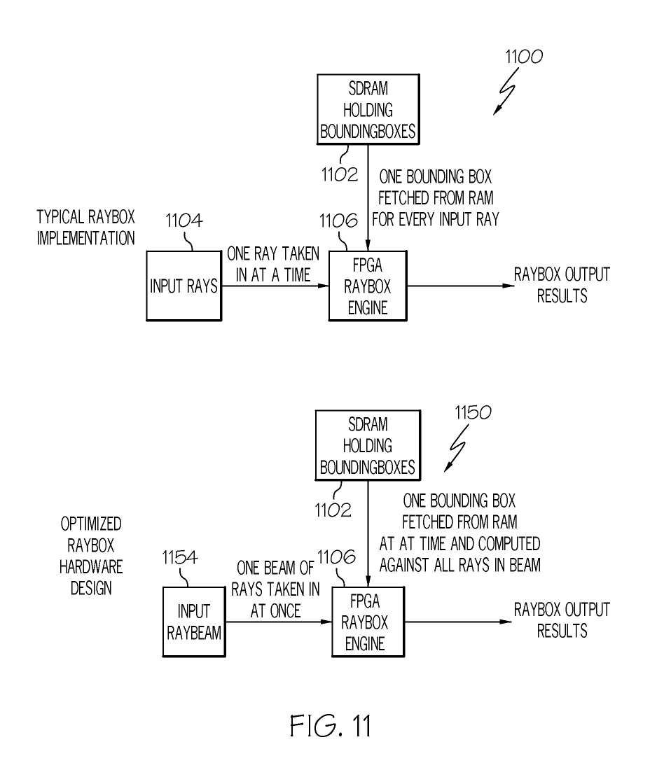

FIG. 12 is one embodiment of an output of a ray-box filter implemented with a ray-beam input. The software is initialized to have zero hits for each ray, and the raybox hardware engine sends output in a compacted format where each ray has an ID and a set of bounding-box IDs/hit-distance values. This achieves a large reduction in output data that needs to be transferred, as only rays and the bounding boxes that actually hit and generate output distance values are packed for sending as output.

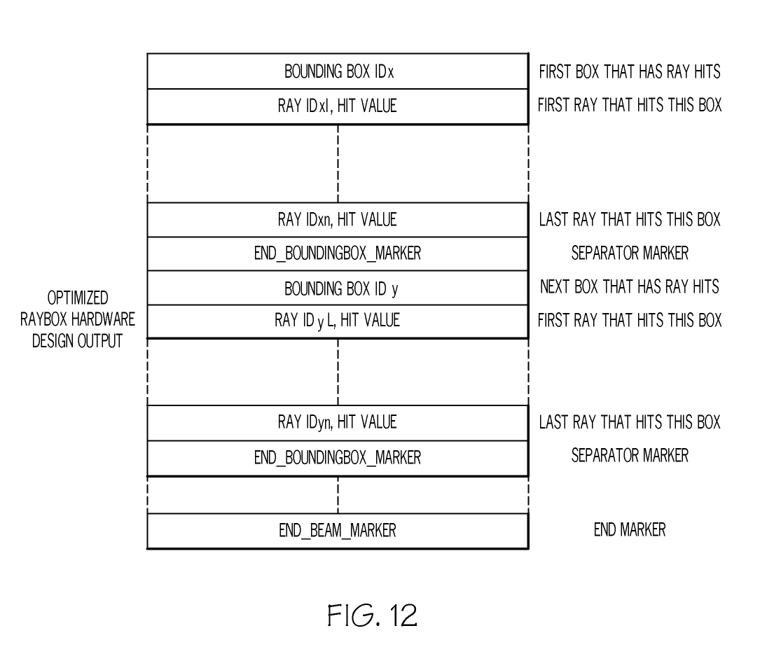

For the ray-box hardware engine to be highly scalable to suit different performance requirements, it needs to be easily replicable so that more ray-box engine cores can be instantiated and used concurrently in parallel on the same hardware FPGA device. In one embodiment, shown in FIG. 13, the ray-box hardware design can be architected to allow for multiple such ray-box engine cores to be instantiated and tied to either the same or different external memory devices, and appear as different ‘streams’ for usage by different software threads that can utilize them independently. This allows for an arbitrary number of such ray-box cores to be used to achieve desired performance levels, and is only limited by the amount of hardware real-estate available.

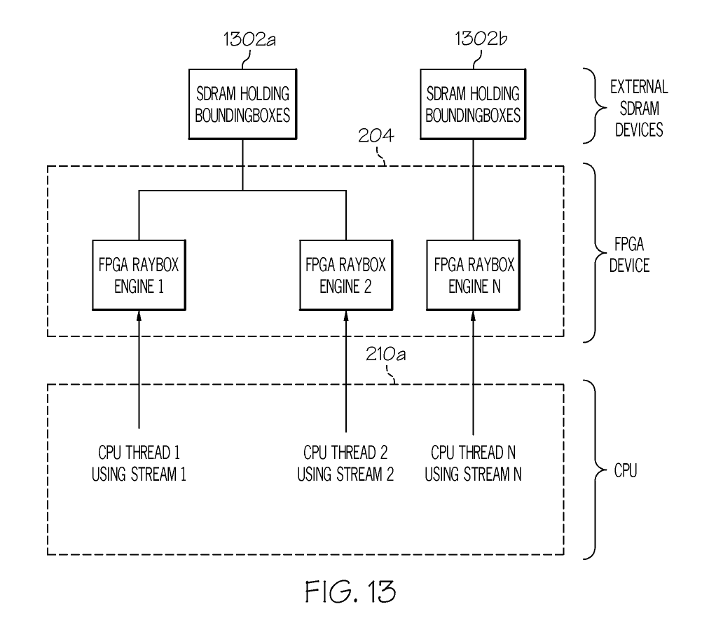

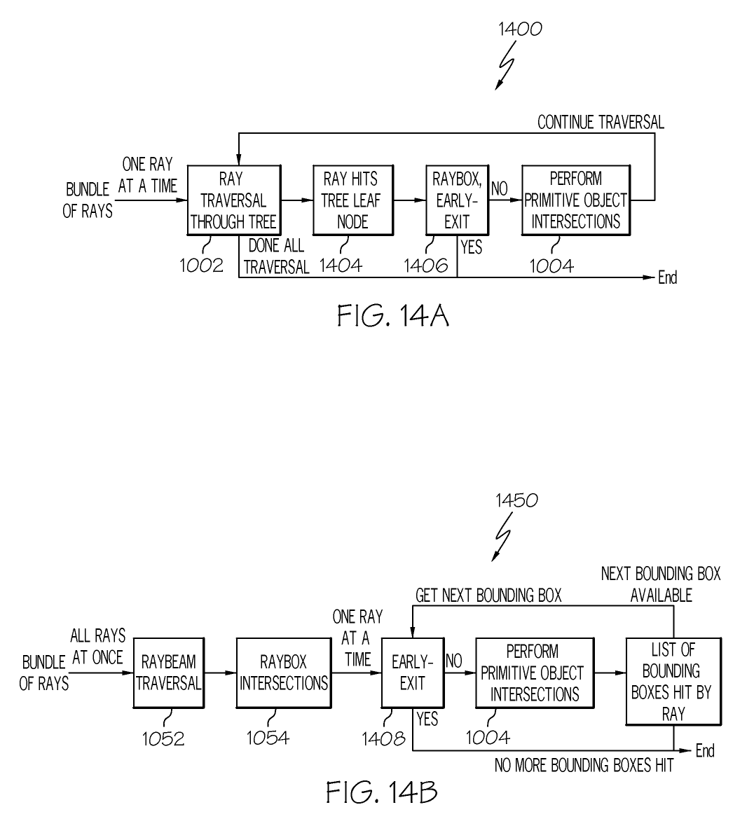

With reference to FIG. 14A, in a ray-tracing flow 1400 where each ray is processed one at a time going through traversal and intersections, there is usually an “early-exit” stage 1406 that stops the ray traversal if a subsequent leaf hit ray-box distance value is greater than the last primitive object hit distance result obtained. This stage reduces the amount of primitive object intersections that need to be done, since primitive object hit distance values larger than the last minimum value obtained are not useful.

In using ray-beam traversal, since all the rays go through traversal and ray-box intersections at once, there is no need for feedback to continue traversal. In one embodiment, shown in FIG. 14B, a workflow employs the list of bounding boxes obtained for each ray from the ray-box intersections stage in order to leverage early-exit so as to avoid doing unnecessary primitive object intersection calculations. An early-exit evaluation 1408 and primitive intersection computations 1004 are done for each ray going through its corresponding list sequentially, so that once early-exist test returns true, the list is not iterated through further and the ray-tracing for that particular ray ends.

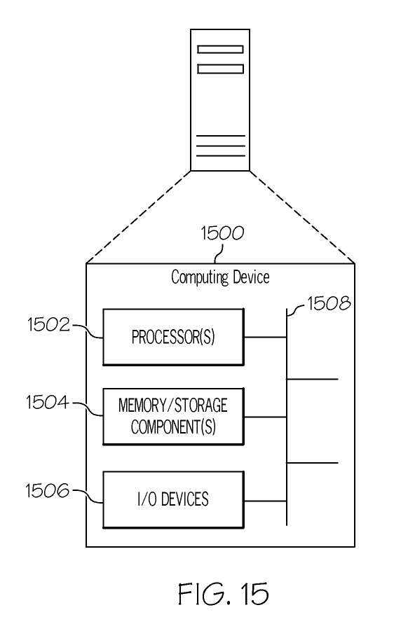

FIG. 15 illustrates one embodiment of a computing environment. In various embodiments, as shown in FIG. 15 some aspects of the techniques described in the present disclosure relating to rendering two-dimensional (2D) representations of three-dimensional (3D) scenes composed of shapes using raytracing, and more particularly to techniques for accelerating computations necessary for such raytracing rendering using field programmable gate array processors may be implemented in a general purpose computing environment. Accordingly, a computing device 1500 may be employed to implement one or more of the computing devices discussed hereinabove. For the sake of clarity, the computing device 1500 is described herein in the context of a single computing device. It is to be appreciated and understood, however, that any number of suitably configured computing devices can be used to implement any of the described embodiments. For example, in at least some implementations, multiple communicatively linked computing devices are used. One or more of these devices can be communicatively linked in any suitable way such as via one or more networks. One or more networks can include, without limitation: the Internet, one or more local area networks (LANs), one or more wide area networks (WANs) or any combination thereof.

In this example, the computing device 1500 comprises one or more processor circuits or processing units 1502, one or more memory circuits and/or storage circuit component(s) 1504 and one or more input/output (I/O) circuit devices 1506. Additionally, the computing device 1500 comprises a bus 1508 that allows the various circuit components and devices to communicate with one another. The bus 1508 represents one or more of any of several types of bus structures, including a memory bus or memory controller, a peripheral bus, an accelerated graphics port, and a processor or local bus using any of a variety of bus architectures. The bus 1508 may comprise wired and/or wireless buses.

The processing unit 1502 may be responsible for executing various software programs such as system programs, applications programs, and/or modules to provide computing and processing operations for the computing device 1500. The processing unit 1502 may be responsible for performing various voice and data communications operations for the computing device 1500 such as transmitting and receiving voice and data information over one or more wired or wireless communications channels. Although the processing unit 1502 of the computing device 1500 includes single processor architecture as shown, it may be appreciated that the computing device 1500 may use any suitable processor architecture and/or any suitable number of processors in accordance with the described embodiments. In one embodiment, the processing unit 1502 may be implemented using a single integrated processor.

The processing unit 1502 may be implemented as a host central processing unit (CPU) using any suitable processor circuit or logic device (circuit), such as a as a general purpose processor. The processing unit 1502 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device, such as a DSP in accordance with the described embodiments.

As shown, the processing unit 1502 may be coupled to the memory and/or storage component(s) 1504 through the bus 1508. The memory bus 1508 may comprise any suitable interface and/or bus architecture for allowing the processing unit 1502 to access the memory and/or storage component(s) 1504. Although the memory and/or storage component(s) 1504 may be shown as being separate from the processing unit 1502 for purposes of illustration, it is worthy to note that in various embodiments some portion or the entire memory and/or storage component(s) 1504 may be included on the same integrated circuit as the processing unit 1502. Alternatively, some portion or the entire memory and/or storage component(s) 1504 may be disposed on an integrated circuit or other medium (e.g., hard disk drive) external to the integrated circuit of the processing unit 1502. In various embodiments, the computing device 1500 may comprise an expansion slot to support a multimedia and/or memory card, for example.

The memory and/or storage component(s) 1504 represent one or more computer-readable media. The memory and/or storage component(s) 1504 may be implemented using any computer-readable media capable of storing data such as volatile or non-volatile memory, removable or non-removable memory, erasable or non-erasable memory, writeable or re-writeable memory, and so forth. The memory and/or storage component(s) 1504 may comprise volatile media (e.g., random access memory (RAM)) and/or nonvolatile media (e.g., read only memory (ROM), Flash memory, optical disks, magnetic disks and the like). The memory and/or storage component(s) 1504 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1506 allow a user to enter commands and information to the computing device 1500, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 1500 may comprise an alphanumeric keypad coupled to the processing unit 1502. The keypad may comprise, for example, a QWERTY key layout and an integrated number dial pad. The computing device 1500 may comprise a display coupled to the processing unit 1502. The display may comprise any suitable visual interface for displaying content to a user of the computing device 1500. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1502 may be arranged to provide processing or computing resources to the computing device 1500. For example, the processing unit 1502 may be responsible for executing various software programs including system programs such as operating system (OS) and application programs. System programs generally may assist in the running of the computing device 1500 and may be directly responsible for controlling, integrating, and managing the individual hardware components of the computer system. The OS may be implemented, for example, using products known to those skilled in the art under the following trade designations: Microsoft Windows OS, Symbian OSTM, Embedix OS, Linux OS, Binary Run-time Environment for Wireless (BREW) OS, JavaOS, Android OS, Apple OS or other suitable OS in accordance with the described embodiments. The computing device 1500 may comprise other system programs such as device drivers, programming tools, utility programs, software libraries, application programming interfaces (APIs), and so forth.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

It also is to be appreciated that the described embodiments illustrate example implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

It is worthy to note that any reference to “one embodiment” or “an embodiment” means that a particular feature, structure, or characteristic described in connection with the embodiment is included in at least one embodiment. The appearances of the phrase “in one embodiment” or “in one aspect” in the specification are not necessarily all referring to the same embodiment.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patent applications cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual aspects described and illustrated herein has discrete components and features which may be readily separated from or combined with the features of any of the other several aspects without departing from the scope of the present invention. Any recited method can be carried out in the order of events recited or in any other order which is logically possible.

The foregoing description is provided as illustration and clarification purposes only and is not intended to limit the scope of the appended claims to the precise forms described. Other variations and embodiments are possible in light of the above teaching, and it is thus intended that the scope of the appended claims not be limited by the detailed description provided hereinabove. Although the foregoing description may be somewhat detailed in certain aspects by way of illustration and example for purposes of clarity of understanding, it is readily apparent to those of ordinary skill in the art in light of the present teachings that certain changes and modifications may be made thereto without departing from the scope of the appended claims. Furthermore, it is to be understood that the appended claims are not limited to the particular embodiments or aspects described hereinabove, and as such may vary. It is also to be understood that the terminology used herein is for the purpose of describing particular embodiments and aspects only, and is not intended to limit the scope of the appended claims.

While certain features of the embodiments have been illustrated as described above, many modifications, substitutions, changes and equivalents will now occur to those skilled in the art. It is therefore to be understood that the appended claims are intended to cover all such modifications and changes as fall within the scope of the disclosed embodiments.

What is claimed is:

1. A hybrid raytracing apparatus, comprising:
a configurable logic circuit programmable to implement a tree traversal algorithm;
an intersection processor configurable to implement a ray-triangle intersection algorithm, wherein the intersection processor is in data communication with the field programmable gate array; and
a central processor configurable to control the field programmable gate array and the intersection processor.

2. The hybrid raytracing apparatus of claim 1, wherein the intersection processor is a graphics processor.

3. The hybrid raytracing apparatus of claim 1, wherein the intersection processor is a field programmable gate array.

4. The hybrid raytracing apparatus of claim 1, wherein the intersection processor is a central processor.

5. The hybrid raytracing apparatus of claim 1, comprising:
a block random access memory configurable to store tree structure data in data communication with the logic circuit.

6. The hybrid raytracing apparatus of claim 5, comprising
a high speed static random access memory in data communication with the block random access memory, wherein the high speed static random access memory is configurable to provide the logic circuit with the tree structure data.

7. The hybrid raytracing apparatus of claim 1, wherein the logic circuit is configured with at least one tree traversal core comprising:
at least one floating point computational circuit;
at least one control logic circuit; and
at least one memory storage element;
wherein the elements are configured to carry out the tree traversal algorithm.

8. The hybrid raytracing apparatus of claim 1, further comprising at least one primary first-in-first-out memory storage element in data communication with the tree traversal cores.

9. The hybrid raytracing apparatus of claim 8, further comprising at least one secondary first-in-last-out memory storage element in data communication with the tree traversal cores.

10. The hybrid raytracing apparatus of claim 5 wherein the block random access memory is on-chip.

11. The hybrid raytracing apparatus of claim 5, wherein the block random access memory is off-chip.

12. The hybrid raytracing apparatus of claim 5, wherein the block random access memory comprises:
a first block random access memory locatable on-chip; and
a second block random access memory locatable off-chip.

13. A logic element for tree traversal comprising:
at least one processor core comprising:
a first input to receive a ray;
a second input to receive a node;
an intersecting block to determine if there is an intersection between the ray and the node, wherein the intersecting block is configured to output the node if the node is a leaf node, and wherein the intersecting block is configured to output at least one child node if the node is not a leaf node;
a primary memory storage unit configurable to store the at least one child node;
a secondary memory storage unit configurable to store the at least one child node; and
a decision logic circuit, configurable to determine whether a node should be stored in the primary storage unit or in the secondary storage unit.

14. The logic element of claim 13, further comprising an output stack configurable to receive at least one leaf node.

15. The logic element of claim 13, wherein the primary memory storage unit is a first-in-first-out storage register.

16. The logic element of claim 13, wherein the secondary memory storage unit is a first-in-last-out storage register.

17. The logic element of claim 13, wherein the intersecting block comprises:
at least one subtractor circuit;
at least one multiplier circuit; and
at least one comparator circuit, wherein the at least one subtractor, the at least one multiplier, and the at least one comparator are configurable to perform an intersection test.

18. The logic element of claim 13 further comprising a first-in-first-out storage register connected to the second input, wherein the first-in-first-out storage register is configurable to store at least one node.

19. The logic element of claim 13 further comprising a first-in-first-out storage register connected to the first input, wherein the first-in-first-out storage register is configurable to store at least one ray.

20. The logic element of claim 13 further comprising a third input configurable to receive node data from the primary storage device and secondary storage device.

21. A method for tree traversal, comprising:
receiving, by a logic circuit, at least one ray packet containing at least one ray;
receiving, by the logic circuit, at least one node of a k-dimensional (KD) tree;
traversing the KD tree, by the logic circuit, by performing an intersection test between the at least one ray and the at least one node;
wherein if the intersection test is positive, performing, via the logic circuit, a leaf node test, wherein if the leaf node test is positive a leaf node is output; and
wherein if the leaf node test is negative, calculating, by a floating point processor, two intersection intervals, wherein the intersection intervals are used by at least one child node of the at least one node for intersection tests, and wherein the at least one child node are output for continued tree traversal.

22. The method of claim 21, further comprising processing the at least one node in a depth breadth search algorithm.

23. The method of claim 21, further comprising performing the traversal of the KD tree by testing only a first ray and a second ray which define the outer bounds of a ray-beam.

24. The method of claim 23, further comprising performing, via the logic circuit, a ray-box intersection test.

25. The method of claim 24, further comprising performing the ray-box intersection test by simultaneously testing a single bounding box against at least one ray that comprise the ray-beam.

26. The method of claim 24, further comprising:
performing, via the logic circuit, an early-exit test using at least one bounding box obtained from the ray-box intersection test.
